(19) United States
(12) Patent Application Publication
(10) Pub. No.: US 2015/0283690 A1
(43) Pub. Date: Oct. 8, 2015

(54) HAND-HELD OR SEMI-STATIONARY TOOL APPLIANCE AND METHOD FOR OPERATING A TOOL APPLIANCE OF THIS KIND

(71) Applicant: HILTI AKTIENGESELLSCHAFT, Schaan (LI)

(72) Inventors: Norbert Welte, Klaus (AT); Roland Mandel, Lindau (DE); Thorsten Sauer, Gofis (AT); Klaus Bertsch, Feldkirch (AT)

(21) Appl. No.: 14/440,729

(22) PCT Filed: Dec. 10, 2013
(86) PCT No.: PCT/EP2013/076047

§ 371 Date: May 5, 2015

(30) Foreign Application Priority Data
Dec. 13, 2012 (DE) 10 2012 223 007.6

(51) Int. Cl. B25F 5/00; G01L 5/00; G01H 1/00; B25C 1/00; G01P 15/00

(52) U.S. Cl. CPC B25F 5/00; B25C 1/008; G01P 15/00; G01H 1/00; G01L 5/00

(57) ABSTRACT

The invention relates to a handheld or semi-stationary tool appliance (1), having a device for detecting and/or storing appliance-related operating data and/or load states. In order to further simplify operation of handheld or semi-stationary tool appliances and/or to extend service intervals or service life of said tool appliances, the tool appliance (1) comprises at least one sensor device (10) for detecting appliance-related forces, accelerations, movements, oscillation frequencies and/or oscillation amplitudes.

### TECHNICAL FIELD

The invention pertains to a hand-held or semi-stationary tool appliance having a device for detecting and/or storing appliance-related operating data or load states. The invention further pertains to a method for operating such a tool appliance.

### PRIOR ART

The hand-held tool appliance can be a hand-held fastener-driving tool, for example, as disclosed in German Offenlegungsschriften DE 10 2006 000 517 A1 and DE 10 2006 035 460 A1. The hand-held tool appliance can also be a hand tool as described in German Patent No. DE 33 10 371 C1.

German Offenlegungsschrift No. DE 101 56 218 A1 discloses a hand-held or semi-stationary electric power tool having a device for storing machine-related data and a device for detecting load states during operation of the electric tool appliance and for converting the detected load states into load data storable in the storage device, wherein an internal or external processor-controlled device is used for processing the load data, for obtaining a service prediction and a prediction of the remaining malfunction-free operating period or for outputting a fault message.

### PRESENTATION OF THE INVENTION

The problem addressed by the invention is that of further simplifying the operation of hand-held or semi-stationary tool appliances and/or extending their service intervals or service life.

For a hand-held or semi-stationary tool appliance having a device for detecting and/or storing appliance-related operating data and/or load states, the problem is solved in that the tool appliance comprises at least one sensor device for detecting appliance-related forces, accelerations, movements, vibration frequencies and/or vibration amplitudes. Inferences relating to a user's behavior and/or a current operational use of the tool appliance can advantageously be drawn from the physical quantities detected with the sensor device. This provides the advantage, among others, that a service interval can be better adapted than is currently the case to the actual load on the tool appliance or to the user's behavior. Thereby the service life of the tool appliance can be maximally utilized. In addition, downtime of the tool appliance can be reduced by service adapted to needs.

A preferred embodiment of the hand-held or semi-stationary tool appliance is characterized in that the sensor device comprises a force sensor, an acceleration sensor, a movement sensor and/or a vibration sensor. For example, situations in which the tool appliance is not being used correctly can be detected with the sensor or sensors.

Another preferred embodiment of the hand-held or semi-stationary tool appliance is characterized in that at least one force sensor is positioned in an anterior end region of the tool appliance in such a manner that solid-borne sound emitted by the tool appliance during operation can be detected. Thereby, application-specific operating data can be detected and evaluated particularly effectively.

Another preferred embodiment of the hand-held tool appliance or semi-stationary tool appliance is characterized in that the tool appliance comprises a blocking actuator with which the tool appliance can be blocked. A safety-relevant shut-off of the tool appliance can be forced in a simple manner by the blocking actuator.

Another preferred embodiment of the hand-held or semi-stationary tool appliance is characterized in that the tool appliance comprises a control actuator with which appliance-related settings can be made. Like the blocking actuator, the control actuator is preferably triggered by an internal control device in the appliance, the control device being advantageously combined with an evaluation unit. The evaluation unit is in turn connected to the sensor device.

Another preferred embodiment of the hand-held or semi-stationary tool appliance is characterized in that the tool appliance is designed as a nailer, or a hand-held driving tool or fastener-setting tool. The fastener-setting tool can be a fuel-operated, pneumatic or electrically driven fastener-setting tool. The service life of all fastener-setting tools depends strongly on proper use and handling of the tools. Improper use can be avoided or reduced by the design of the tool appliance according to the invention.

In a method for operating a tool appliance as described above, the above-specified problem is alternatively or additionally solved by evaluating the operating data and/or load states detected with the sensor device and using them to create a load profile. The load profile can be produced internally in the appliance or externally.

A preferred embodiment of the method is characterized in that internal factors of the appliance or external factors are taken into consideration in creating the load profile. The external factors have an influence on the load on the tool appliance during operation. These include, for example, environmental conditions such as an underlying surface into which a fastening element is to be driven, the nature of a fastening element, the air humidity or the air pressure. In addition, the factors external to the device include user influences or application influences, such as a blow to or dropping of the tool appliance. Factors internal to the device include, for example, status monitoring, wear detection, setting detection or equipment detection of the tool appliance.

Another preferred embodiment of the method is characterized in that information regarding proper or improper operation of the tool appliance is displayed to a user during operation of the tool appliance. The information is preferably displayed on the exterior of the tool appliance with a display device and/or output via a communications interface such as a mobile telephone or some other mobile communication device.

Another preferred embodiment of the method is characterized in that the tool appliance is blocked if a critical operating state is detected with the sensor device. Thereby a safety-relevant shut-off can be forced in a simple manner.

Other advantages, features, and details of the invention can be deduced from the following description in which various embodiments are described in detail with reference to the drawing.

The sole appended FIGURE shows a simplified representation of a tool appliance according to the invention in a longitudinal section.

### EMBODIMENTS

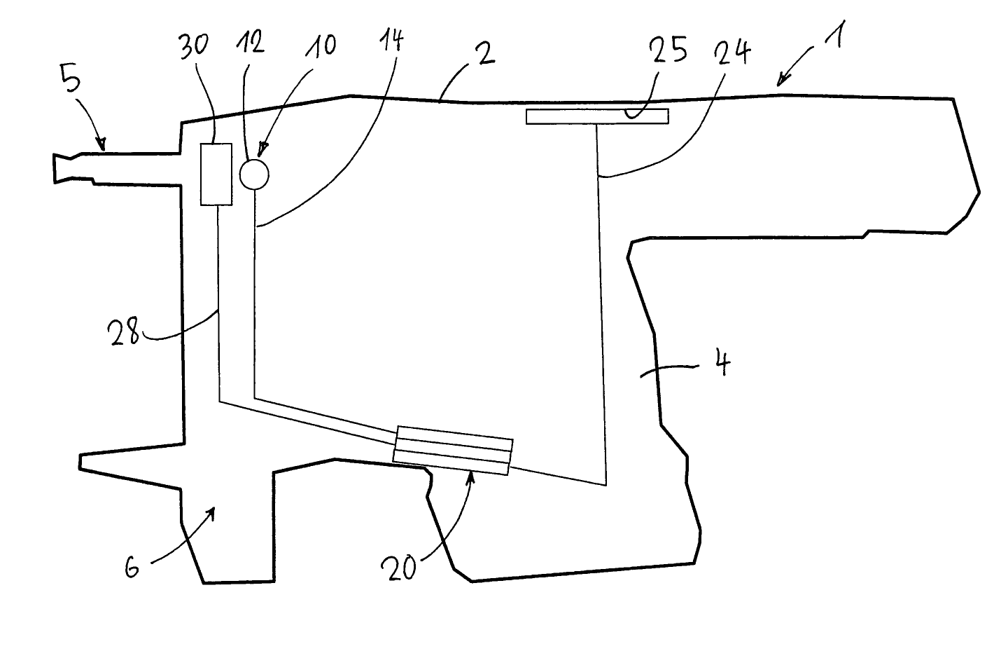

FIG. 1 shows a simplified view of a fastener-setting tool 1 having a housing 2 and a handle 4 in longitudinal section. The tool appliance 1 is an electrically driven fastener-setting tool. The invention is also applicable to fuel-driven or pneumatic fastener-setting tools, however. Furthermore, the invention can be used in other tool appliances such as drills.

The tool appliance 1 is used for driving fastening elements into an underlying surface (not shown). The fastening elements exit from the tool appliance 1 at a setting end 5.

The fastening elements used are provided via an internal magazine 6 that is mounted in the vicinity of the fastener-setting end 5 of the tool appliance 1. The fastening elements are preferably removed automatically and individually from the magazine 6 and provided at the setting end 5.

The energy required for driving the fastening elements into the underlying surface is provided electrically in the present example. Alternatively, the energy required for driving the fastening elements into the underlying surface can be provided in a fuel container in the interior of the tool appliance. In addition, the energy required for driving the fastening elements into the underlying surface can be provided pneumatically.

The tool appliance 1 according to the invention comprises a sensor device having at least one sensor device 10. Physical quantities such as force, acceleration, pressure, time, temperature, frequency and amplitude of vibrations, energy and the like are detected with one or more sensors.

In addition, inferences regarding the user's behavior and/or the usage of the tool appliance are drawn from the information and/or data detected by the sensor device 10. An actual load profile of the tool appliance 1 and/or of individual components of the tool appliance 1 is derived from these data.

For example, if an operator or user allows the tool appliance 1 to bounce or uses unsuitable, e.g. excessively short, fastening elements, in particular nails, this can be recognized by the sensor device 10. The usage of excessively short nails could cause the setting energy provided in the tool appliance 1 to not be completely dissipated.

For a conventional tool appliance, this would cause a part of the provided energy to be diverted into a buffer or into other system components. With the sensor device according to the invention, higher loads on the tool appliance 1 can be recognized, evaluated and saved or stored as a load profile.

Service life predictions for individual components of the tool appliance 1 and of the entire system can be derived via an accumulation of damage. Moreover, a variable service interval is generated. The service interval is as long as possible and reliably responds before a potential system failure.

In a method according to the invention for operating the tool appliance 1, various measures are initiated that protect the system, enable optimally long usage times and prevent unsafe states. In particular, the measures include the following:
user information about proper/improper use of the system;
extension of the service interval if the system is used carefully;
shortening the service interval in the case of an elevated load on the system;
documentation of the load profile (e.g. for service);
outputting the load profile (via interface, display, signaling);
blocking the system if an unsafe system state occurs;
blocking the system to avoid follow-on damage;
indication that service is due;
recognition of the applied settings based on the load profile;
derivation of optimized appliance settings.

Both external and internal factors of the system can be drawn upon and taken into account before creating the load profile.

External factors influencing the load on the system are, for example:
use of the appliance (underlying surface, fasteners, nails, temperature, humidity, air pressure, misuse, setting without fasteners . . . );
user influence (impact on the appliance, dropping of the appliance, allowing the appliance to bounce, strong/weak/slanted pressing).

Internal factors are, for example:
state monitoring (appliance tensioned, piston fault . . . );
wear detection (buffer, piston, bearings . . . );
adjustment detection (energy adjustment, excess energy . . . );
equipment detection (fastener guide, piston, cartridges . . . ).

The sensor device 10 comprises an acceleration sensor 12 with which the solid-borne sound of the tool appliance 1 is recorded during each fastener setting. The sensor device 10 is connected electronically via a connecting line 14 to an evaluation and control unit 20. The evaluation and control unit 20 is connected by an additional connecting line 24 to a display device 25 comprising a display. In embodiments not shown, the evaluation and control unit is connected to a communications interface, which outputs the relevant information to a mobile telephone or similar mobile application device, more particularly via wireless transmission such as GSM. The evaluation and control unit 20 is connected via an additional connecting line 28 to an actuator 30.

A signal from the sensor device 10 is analyzed in the evaluation and control unit 20. A variety of information such as use, misuse, appliance lifetime and the like can be derived therefrom. Based on usage information, damage levels for components of the tool appliance 1 such as buffers, pistons or belts are accumulated. If one of the components reaches a predetermined service value, this is signaled visually on the display of the display device 25 on the exterior of the tool appliance 1. Signaling can also use an acoustic signal.

The tool appliance 1 can be blocked by means of the actuator 30 in order to force a safety-relevant shutdown. In addition, system settings can also be made via one or more additional actuators (not shown).

The tool appliance 1 according to the invention having the sensor device 10 enables the following functions, among others.

For example, the following can be recognized and taken into consideration as a usage detector: normal use, misuse, setting failure, setting cadence, number of settings, setting profile, application direction.

Moreover, development data that are important for tool development can be logged and/or stored. In addition, malfunctions such as delayed ignitions or failed ignitions can be recognized early before a breakdown occurs.

As a failure detector, failures of components such as a belt or spring can be predicted better. By measuring energy, it is possible to determine whether combustion is running well or poorly. Wear and tear on components of the tool appliance 1 such as buffers, gear units, bearings, pistons or belts can be detected. An initial calibration of the tool appliance 1 can be undertaken with the aid of the sensor device 10. Thus the tool appliance 1 can be calibrated before delivery based on ten fastener settings for example.

A usage-dependent service interval can be determined on the basis of a number of misuses and/or user behavior, for example in case of a dropped tool. In addition, improper usage such as blows to or dropping of the tool appliance 1 can be signaled. According to another aspect of the invention, a manual switch in the tool appliance 1 can be omitted, because the tool appliance 1 can also be activated with the aid of the sensor device 10 by shaking.

1. A hand-held or semi-stationary tool appliance, for detecting and/or storing appliance-related operating data and/or load states, comprising at least one sensor device for detecting appliance-related forces, accelerations, movements, vibration frequencies and/or vibration amplitudes.

2. The hand-held or semi-stationary tool appliance according to claim 1, wherein the sensor device comprises a force sensor, an acceleration sensor, a motion sensor and/or a vibration sensor.

3. The hand-held or semi-stationary tool appliance according to claim 1, wherein at least one force sensor is positioned in an anterior end region of the tool appliance such that solid-borne sound emitted by the tool appliance during operation is detected.

4. The hand-held or semi-stationary tool appliance according to claim 1, comprising a blocking actuator capable of blocking the tool appliance.

5. The hand-held or semi-stationary tool appliance according to claim 1, comprising a control actuator capable of performing appliance-related adjustments.

6. The hand-held or semi-stationary tool appliance according to claim 1, comprising a nailer, a hand-held fastener-driving tool, or a fastener-setting tool.

7. A method for operating the hand-held or semi-stationary tool appliance according to claim 1, the method comprising detecting, the operating data and/or load states with the sensor device; evaluating the operating data and/or load states; and, creating a tool appliance load profile.

8. The method according to claim 7, including considering internal factors or external factors while creating the load profile.

9. The method according to claim 7, including displaying information regarding proper or improper operation of the tool appliance to a user during operation of the tool appliance.

10. The method according to claim 7, including blocking the tool appliance if a critical operating state is detected by the sensor device.

11. The hand-held or semi-stationary tool appliance according to claim 2, wherein at least one force sensor is positioned in an anterior end region of the tool appliance such that solid-borne sound emitted by the tool appliance during operation is detected.

12. The hand-held or semi-stationary tool appliance according to claim 2, comprising a blocking actuator capable of blocking the tool appliance.

13. The hand-held or semi-stationary tool appliance according to claim 3, comprising a blocking actuator capable of blocking the tool appliance.

14. The hand-held or semi-stationary tool appliance according to claim 2, comprising a control actuator capable of performing appliance-related adjustments.

15. The hand-held or semi-stationary tool appliance according to claim, comprising a control actuator capable of performing appliance-related adjustments.

16. The hand-held or semi-stationary tool appliance according to claim 4, comprising a control actuator capable of performing appliance-related adjustments.

17. The hand-held or semi-stationary tool appliance according to claim 2, comprising a nailer, a hand-held fastener-driving tool, or a fastener-setting tool.

18. The hand-held or semi-stationary tool appliance according to claim 3, comprising a nailer, a hand-held fastener-driving tool, or a fastener-setting tool.

19. The hand-held or semi-stationary tool appliance according to claim 4, comprising a nailer, a hand-held fastener-driving tool, or a fastener-setting tool.

20. The hand-held or semi-stationary tool appliance according to claim 5, comprising a nailer, a hand-held fastener-driving tool, or a fastener-setting tool.
